(19) United States
(12) Patent Application Publication
(10) Pub. No.: US 2013/0311229 A1
(43) Pub. Date: Nov. 21, 2013

(54) PROACTIVE RISK ASSESSMENT FOR SYSTEM ARCHITECTURE EVOLUTIONS

(71) Applicants: Eitan HADAR, Nesher (IL); Donald F. Ferguson, South Salem, NY (US)

(72) Inventors: Eitan HADAR, Nesher (IL); Donald F. Ferguson, South Salem, NY (US)

(73) Assignee: CA, INC., Islandia, NY (US)

(21) Appl. No.: 13/472,857

(22) Filed: May 16, 2012

(51) Int. Cl. G06Q 10/06

(52) U.S. Cl. 705/7.28

(57) ABSTRACT

Risks from system architecture evolutions are assessed by an apparatus that comprises a database comprising a plurality of roadmaps for a corresponding plurality of components that may be used to form an enterprise architecture, the roadmaps identifying the planned characteristics of the plurality of components. The apparatus also comprises a modeling module executed by a processor to identify the components that form the enterprise architecture, to identify the current characteristics of those components, and to map those components to the roadmaps for corresponding components among the plurality of components in the database. In addition, the apparatus comprises a risk identification module executed by the processor to identify which of the components that form the enterprise architecture have current characteristics that are different from the corresponding planned characteristics.

### BACKGROUND

The present disclosure generally relates to risk assessment. The disclosed embodiments relate more specifically to a system, apparatus, method, and computer program product for proactively assessing the risk of compatibility issues that might result from system architecture evolutions.

Information technology (IT) is essential to driving the growth of service-based business (e.g., business service providers) and creating a competitive advantage for such businesses. Business service providers not only rely on IT to conduct their day-to-day business, but also to offer new services, comply with regulations, manage resources, and drive innovation. Thus, business service providers can leverage IT to move their businesses forward.

Business service providers often leverage IT to move their businesses forward through management and integration. For example, business service providers may employ an enterprise architecture to provide organized logic for business processes and IT infrastructures that reflect the integration and standardization requirements of that business service provider in accordance with the manner in which that business service provider desires to deliver goods and services to its customers. But as technology has evolved, IT management has become far more difficult, particularly with respect to risk management.

Making business-centric IT decisions based on risk drives the future design and intent of the enterprise architecture landscape. But such risk-based decision-making is complex due to its cross disciplinary implications. For example, enterprise architectures involve every facet, dimension, and aspect of the business service provider's business and, therefore, effect everyone at the personal and corporate level, as well as system integrations during the planning, development, design, operation, and management of the enterprise architecture. Accordingly, enterprise architectures may involve thousands of solution architectures, applications, networks, databases, hardware, software, middle-ware, business processes, operations, lines of business, support, projects, departments, politics, etc. And the business service provider must make trade-offs among all the relevant and important costs, benefits, and risks in a multi-object framework, without quantitative methodologies with which to commensurate those costs, benefits, and risks.

### BRIEF SUMMARY

The present disclosure is directed to system, apparatus, method, and computer program product for assessing risks driven from system architecture evolutions. According to one aspect of the present disclosure, the apparatus comprises a database comprising a plurality of roadmaps for a corresponding plurality of components that may be used to form an enterprise architecture, the roadmaps identifying the planned characteristics of the plurality of components. The apparatus also comprises a modeling module executed by a processor to identify the components that form the enterprise architecture, to identify the current characteristics of those components, and to map those components to the roadmaps for corresponding components among the plurality of components in the database. In addition, the apparatus comprises a risk identification module executed by the processor to identify which of the components that form the enterprise architecture have current characteristics that are different from the corresponding planned characteristics.

### BRIEF DESCRIPTION OF THE DRAWINGS

Aspects of the present disclosure are illustrated by way of example and are not limited by the accompanying figures with like references indicating like elements.

FIG. 1 is a schematic diagram illustrating an example of a communications network according to a non-limiting embodiment of the present disclosure;

FIG. 2 is a schematic diagram illustrating an example of a risk management system according to a non-limiting embodiment of the present disclosure;

FIG. 3 is a flow diagram illustrating an example of a risk management process according to a non-limiting embodiment of the present disclosure.

In those figures, like reference numerals refer to like parts, components, structures, and/or processes.

### DETAILED DESCRIPTION

The system, apparatus, method, and computer program product of the disclosed embodiments proactively identify, assess, and mitigate the risks associated with lack of compatibility and change preparation issues that may arise in enterprise architectures as a result of future changes in the underlying components and their integration of the enterprise architecture. The system, apparatus, method, and computer program product ensure the availability, sustainability, and overall quality of the enterprise architecture.

The system, apparatus, method, and computer program product of the disclosed embodiments provide a roadmap by which business service providers can proactively select how to evolve their enterprise architecture to avoid system down-time when software vendors implement future updates. Moreover, by assessing future updates in terms of risk management, the disclosed embodiments can group different updates based on such factors as release dates of patches, type of operating environment, type of update, and/or type of application. Ultimately, the system, apparatus, method, and computer program product enables IT service providers to capture future changes, analyze them, and predict conflicts well ahead of time, thus providing longer times to assess risks, provide mitigation plans and alternatives, and reduce risks of unexpected down time when the future updates are actually implemented by vendors, such as consolidating a plurality of changes into a single change.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer-readable media having computer-readable program code embodied thereon.

Any combination of one or more computer-readable media may be utilized. The computer-readable media may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer-readable medium that when executed can direct a computer, other programmable data processing apparatus, or other devices to function in a particular manner, such that the instructions when stored in the computer-readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

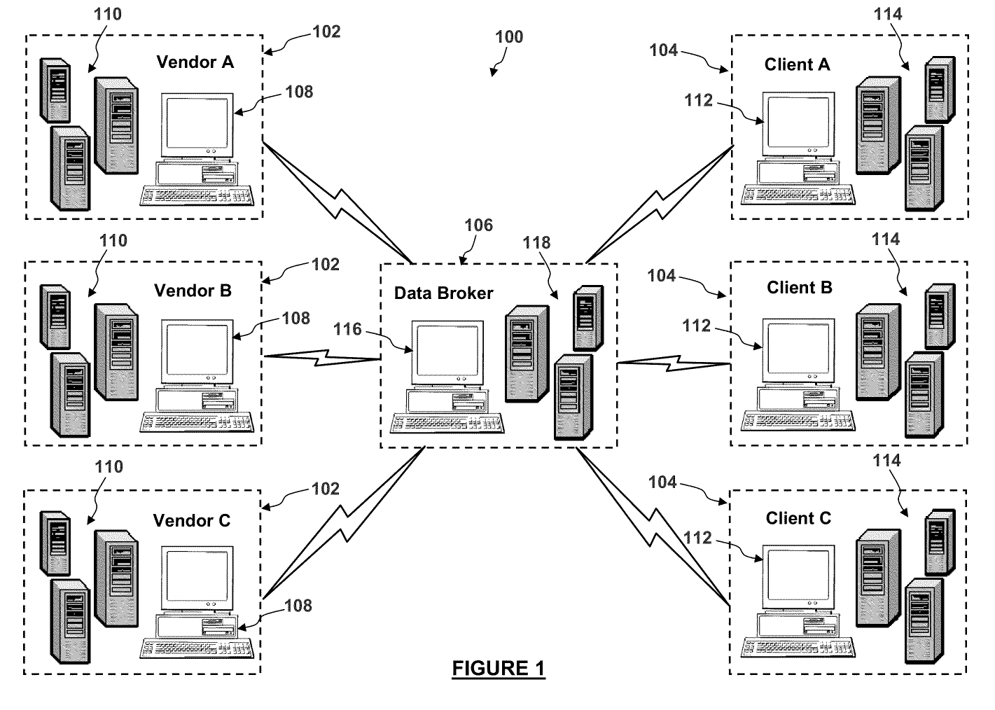

Turning to the drawings, FIG. 1 illustrates a communications network 100, such as the internet, according to a non-limiting embodiment of the present disclosure. The communications network 100 includes a plurality of vendor systems 102, a plurality of client systems 104, and a broker system 106. Each vendor system 102 includes at least one graphical user interface (GUI) 108 and one or more servers 110; each client system 104 includes at least one GUI 112 and one or more servers 114; and the broker system 106 includes at least one GUI 116 and one or more servers 118.

Each system 102-106 within the network 100 and each component 108-116 within each system 102-106 is placed in electronic data communication with each other system 102-106 and component 108-116 via a network connection (e.g., a LAN connection, a WAN connection, a VPN connection, etc.) using a suitable network communications protocol (e.g., the Transmission Control Protocol (TCP), the Internet Protocol (IP), etc.). By virtue of those network connections, none of the systems 102-106 within the network 100 or the components 108-116 within each system 102-106 needs to be proximate to another system 102-106 or component 108-116, or even in the same building, city, state, or country as another system 102-106 or component 108-116. Moreover, each system 102-106 may utilize or provide cloud computing services such that some or all of the data processing performed by that system 102-106 is provided by the cloud computing service.

The vendor systems 102 are maintained and operated by vendors that provide hardware, software, middle-ware, applications, components, and other technologies (hereinafter “products/services/technologies”) that are used by their customers to create enterprise architectures. The client systems 104 are maintained and operated by IT service providers that provide enterprise architecture solutions to various business service providers to provide organized logic for business processes and IT infrastructures that reflect the manner in which those business service providers desire to deliver goods and services to their customers. And the broker system 106 is maintained an operated by a data broker that helps its customers, or clients, identify and manage risks that may arise in those customers' enterprise architectures as a result of future updates to the underlying components of their enterprise architectures.

The IT service providers are the vendors' customers because they obtain products/services/technologies from those vendors to create enterprise architectures for their own customers (e.g., business service providers). The IT providers also are the data broker's customers because they utilize the data broker to help them identify and manage risks that may arise in their own customers' enterprise architectures. And the data broker obtains update information from each vendor on future updates that may be implemented in the products/services/technologies that each vendor provides to the IT providers. The disclosed embodiments help those vendors, IT providers, and data brokers better serve their respective customers.

The vendor systems 102 are configured to communicate with the broker system 106 via the communications network 100 to provide the broker system 106 with the evolution information on the future updates that those vendors may implement. The broker system 106 is configured to communicate with the client systems 104 via the communications network 100 to help the IT providers identify and manage risks to the enterprise architectures of its customers that may arise as a result of the future updates that the vendors may implement. The vendor systems 102 and the client systems 104 also may be in communication with each other via the communications network 100 so that the client systems 104 may receive updates to the software, middle-ware, applications, etc. that those IT providers utilize in their own customer's enterprise systems.

Each GUI 108, 112, and 116 is configured to provide its respective user (e.g., a vendor, an IT provider, or a data broker) with access to the communications network 100 and to allow that user to interact with the communications devices 108-116 within the communications network 100 through direct manipulation of elements presented in a graphical display. Each GUI 108, 112, and 116 may be any suitable communications device with a storage device, an input device, an output device, a communication interface, a memory device, and a processor, or any combination thereof, that are capable of supporting the functionality of that GUI 108, 112, or 116 described below (e.g., a desktop computer, a laptop computer, a tablet computer, a personal digital assistant (PDA), a smart phone, a multimedia tablet, etc.).

For example, each GUI 108, 112, and 116 may include a keyboard, mouse, graphics tablet, joystick, light pen, microphone, scanner, touch screen, RFID reader, or any other device that is configured to facilitate the input, selection, and/or manipulation of data. And the output device may include a video monitor, a digital display, a touch panel, a printer, a plotter, or any other device that is configured to present and/or display data to a user. Examples of storage devices, communication interfaces, memory devices, and processors that may be included in each GUI 108, 112, and 116 are described in more detail below with respect to the servers 110, 114, and 118.

Each server 110, 114, and 118 includes a storage device, a memory device, a processor, and a communication interface, or any combination thereof. The storage device is configured to store data and instructions for performing the various processes that support the functionality of the server 110, 114, or 118 and may include, for example, a magnetic disk, a flash memory, an optical disk, a digital video disk (DVD), a removable storage media, any other suitable data storage device, or a combination of any of the preceding storage devices. The memory device is configured to store and facilitate retrieval of data and may include, for example, a random access memory (RAM), a read only memory (ROM), any other suitable memory device, or a combination of any of the preceding memory devices. The processor is configured to execute instructions and manipulate data to perform the various operations of the server 110, 114, or 118 and may include, for example, any type of central processing unit (CPU). And the communication interface is configured to receive input to the server 110, 114, or 118, to send output from the server 110, 114, or 118, to perform suitable processing of that input and/or output, and to communicate with other communications devices 108-118 within the communications network 100. The communication interface includes the appropriate hardware (e.g., a modem, a serial port, a network interface card, etc.) and software (e.g., protocol conversion software, data processing software, etc.) for supporting that functionality.

Each server 110, 114, and 118 is configured to support the functionality of its corresponding GUI 108, 112, and 116 and to facilitate electronic data communication between that GUI 108, 112, or 116 and the other communication devices 108-116 within the communications network 100. For example, each GUI 108, 112, and 116 may store data on and retrieve data from the storage device of the server 110, 114, or 118 within its corresponding system 102, 104, or 106; each GUI 108, 112, and 116 may rely on the memory device and/or processor of the server 110, 114, or 118 within its corresponding system 102, 104, or 106 to perform more complicated processing; and each GUI 108, 112, and 116 may utilize the communication interface of the server 110, 114, or 118 within its corresponding system 102, 104, or 106 to communicate with communications devices 108-116 outside of its corresponding system 102, 104, or 106. Accordingly, each server 110, 114, and 118 may be provided behind a firewall to protect its corresponding system 102, 104, or 106 from untrustworthy communications devices within the communications network 100.

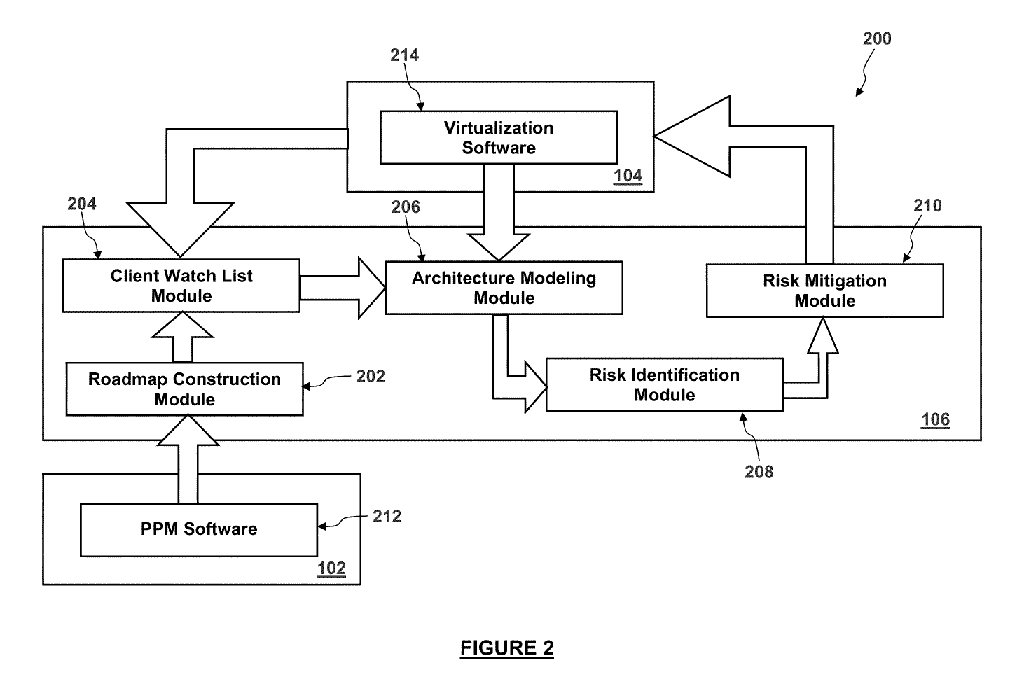

FIG. 2 illustrates a risk management system 200 according to a non-limiting embodiment of the present disclosure. The risk management system is configured to proactively identify, assess, and mitigate the risks associated with lack of compatibility issues that may arise in enterprise architectures as a result of future updates in the underlying components of the enterprise architecture. The risk management system 200 includes a roadmap construction module 202, a client watch list module 204, an architecture modeling module 206, a risk identification module 208, and a risk mitigation module 210. The risk management system 200 may be integrated with Project and Portfolio Planning (PPM) software 212 and/or virtualization software 214 to allow the seamless exchange of data with that software. The vendors and IT providers may access one or more of the modules 202-212 via the communications network 100, such as by navigating to a web page, and may exchange data with the risk management system 200 using the PPM software 212 and virtualization software 214.

As illustrated in FIG. 2, the roadmap construction module 202, a client watch list module 204, an architecture modeling module 206, a risk identification module 208, and a risk mitigation module 210 are provided at the broker system 104; the PPM software 212 is provided at the vendor system 102, and the virtualization software 214 is provided at the IT provider system 104. Those components 202-214 of the disclosed embodiment, however, may be provided in different combinations in different systems 102-106. For example, those components 202-214, or their equivalent functionality may all be provided at the broker system 106. Or all or some of those components 202-214 may be provided in the cloud.

The roadmap construction module 202 is configured to generate a product roadmap for each vendor that registers with the risk management system 200. Product roadmaps are a key deliverable of the product innovation planning process. Vendors utilize product roadmaps as a mechanism to help forecast technology developments and to provide a framework to help plan and coordinate those technology developments. There often are different types of roadmaps in use across a vendor's organization, including strategy, market, product, technology, and feature-function roadmaps. Many roadmaps utilize a graphical, Gantt-style tool that is used internally within a particular organization to depict plans and strategies over a given period.

While vendors once utilized slideshow presentation software (e.g., POWERPOINT brand slideshow presentation software) as the primary medium to communicate their roadmaps, many vendors now use PPM software 212 (e.g., CLARITY brand PPM software) both to generate product roadmaps for the various projects in their the portfolio and to coordinate resources, costs, and schedules across those projects. Such vendors may load their product roadmaps into the risk management system 200 directly from their PPM software 212 via the roadmap construction module 202 or, in the alternative (e.g., if the vendor still utilizes slideshow presentation software to generate roadmaps), vendors may utilize PPM-type functionality provided in the roadmap construction module 202 to manually input the information required to generate a product roadmap. As yet another alternative, the roadmap construction module 202 also may be configured to consume various electronic documents (e.g., slideshow presentation files, document files, scanned images, etc.) and parse out the information required to generate a product roadmap using semantic algorithms.

The information loaded into, manually input into, or consumed by the roadmap construction module 202 may include, for example, product/service/technology name, product/service/technology description, release dates, detailed scope of the release, nature of the update (e.g., fix, service patch, new version), dependency on underlying third-party software, new application programming interface (API) version number, and changes in required utility computing. Vendors also may provide future Open Virtualization Format (OVF) and/or Solution Deployment Descriptor (SDD) version numbers of any services and/or libraries that its products/services/technologies depend upon, as well as any other data that may help define the nature of the planned evolution (e.g., future Web Services Description Language (WSDL) metadata formats). That evolution information is automatically mapped to a particular product/service/technology so that any planned update for that product/service/technology is automatically added to the roadmap for that product/service/technology. The more data each vendor provides, the better the risk management system 200 will be able to identify and predict compatibility issues that may arise from planned updates.

It is not necessary that the roadmap construction module 202 capture all the information about a product/service/technology. Rather, the roadmap construction module 202 may function based on the gradual input of information, which will depend on what information vendors are willing to provide, such that the roadmap construction module 202 operates as a continuously updated registry for a vendor's future product/service/technology evolutions. As it captures that information, the roadmap construction module 202 generates a roadmap of the planned evolution for each of the products/services/technologies offered by a particular vendor, including the identify of any other products/services/technologies that may be effected by that evolution. The roadmap construction module 202 not only provides a central location for capturing evolution information from a large number of vendors, it also provides a central location from which IT providers can access that large pool of information.

The client watch list module 204 is configured to filter the evolution information captured by the roadmap construction module 202 for each IT provider that registers with the risk management system 200 such that each IT provider only receives evolution information for the products/services/technologies that it utilizes, or plans to utilize, in the enterprise architectures that it provides to its customers. IT providers may utilize the client watch list module 204 to set up individualized preferences that establish the products/services/technologies for which that IT provider will receive evolution information, as well as when (e.g., daily, weekly, monthly, on demand, etc.) and how (e.g., in a particular format, via e-mail, via automatic data push or pull, on a non-transitory storage medium, etc.) that IT provider will receive that evolution information.

For example, an IT provider may identify a specific set of products/services/technologies that it utilizes, or plans to utilize, in the enterprise architectures that it provides to its customers. That IT provider also may indicate that it would like to be notified any time the roadmap for any one of the identified products/services/technologies is modified, via an automatic data push to its client system 104, and in a particular data format. In response, the client watch list module 204 will provide that IT provider with a individualized snapshot of only the roadmaps that are relevant or of interest to that IT provider, whenever one of those roadmaps changes, and in the manner and format most useful to that IT provider. Accordingly, the client watch list module 204 provides a central location from which an IT provider can automatically receive evolution information for only the products/services/technologies that it utilizes, as that information changes, rather than having to sort through the large pool of evolution data captured by the roadmap construction module 202 or having to contact each of the corresponding vendors individually to enquire about their respective product/service/technology evolutions.

The architecture modeling module 206 is configured to map the evolution information identified by the client watch list module 204 with system models of the various enterprise architectures that the IT providers provide to their customers. IT providers generally maintain a repository, or database, of the system models for each of the enterprise architectures it provides its customers. IT providers often express the structures and behaviors of their customers' enterprise architectures as abstractions in system models using virtualization software (e.g., APPLOGIC brand virtualization software). Such virtualization software is disclosed, for example, in co-pending U.S. patent application Ser. No. 12/400,710, the disclosure of which is hereby incorporated by reference as if fully set forth herein. Such IT providers may load their various system models into the risk management system 200 directly from their virtualization software via the architecture modeling module 206 or, in the alternative (e.g., if the IT provider does not model its customers' enterprise architectures with virtualization software in-house), IT providers may utilize virtualization functionality provided in the architecture modeling module 206 to create system models for their customers' enterprise architectures. As yet another alternative, an IT provider can create a system list that includes the various products/services/technologies that make each enterprise architecture in list form, rather than virtualizing those products/services/technologies as abstractions in a system model.

The abstractions provided in the system models not only provide a graphical representation of the various products/services/technologies that make up an enterprise architecture, they also form a cohesive model that can be used to construct, (re)configure, operate, execute, monitor, control, or otherwise manipulate the products/services/technologies that make up that enterprise architecture. Accordingly, each abstraction is associated with metadata that identifies the particular product/service/technology (e.g., vendor name, product/service/technology name, description the of product/service/technology, etc.) as well as its operating characteristics (e.g., speed, capacity, throughput, dependency on underlying third-party software, etc.). Further, that metadata identifies the state-of-evolution (e.g., release date, API version number, OVF version number, SDD version numbers, WSDL metadata format, etc.) of the particular product/service/technology. System lists may include similar metadata.

If an IT provider utilizes the functionality of the architecture modeling module 206 to create system models or system lists for its customers' enterprise architectures, the IT provider can create those system models and/or system lists by selecting the corresponding products/services/technologies from those it identified with the client watch list module 204. The products/services/technologies identified with the client watch list module 204 already are mapped to their corresponding roadmap by the roadmap construction module 202, so no further mapping is required if an IT provider creates a system model or system list using the architecture modeling module 206 to select the various products/services/technologies that make up a particular enterprise architecture. And if an IT provider loads a system model into the risk management system 200 directly from its virtualization software 214 via the architecture modeling module 206, the architecture modeling module 206 will automatically map the products/services/technologies that make up that particular enterprise architecture to the corresponding products/services/technologies captured by the roadmap construction module 202 using the metadata associated with the abstraction of each product/service/technology in that system model. Accordingly, the architecture modeling module 206 not only provides functionality for IT providers to create system models and/or system lists that represent their various enterprise architectures, it also provides functionality that ensures each product/service/technology within those system models and/or system lists is mapped to the corresponding roadmap.

The risk identification module 208 is configured to utilize the system models and system lists created by IT providers and identify any potential risks associated with any one or more product/service/technology that makes up a particular enterprise architecture. Because the architecture modeling module 206 ensures that each product/service/technology within a particular enterprise architecture is mapped to the corresponding evolution roadmap, the risk identification module 208 can identify both existing compatibility issues and potential compatibility issues that may arise for each individual product/service/technology, as well as to the enterprise architecture as a whole. For example, the risk identification module 208 may use the state-of-evolution metadata associated with each product/service/technology in a system model or system list and compare it to the evolution information in the corresponding roadmap to identify any product/service/technology that currently is obsolete or compromised due to some previous evolution of that product/service/technology or of some product/service/technology on which it depends. Similarly, the risk identification module 208 may use that same information to identify any product/service/technology that may become obsolete or compromised in the future due to some planned evolution of that product/service/technology or of some product/service/technology on which it depends.

Based on the existing compatibility issues and potential compatibility issues that may arise as a result of various product/service/technology evolutions, the architecture modeling module 206 analyzes each enterprise architecture as a whole to evaluate the overall level of risk (e.g., low, normal, high) created by those issues. The architecture modeling module 206 also analyzes the level of risk associated with each product/service/technology so that IT providers may identify which products/services/technologies are contributing most to the overall level of risk. Those risks are evaluated in terms of the underlying evolution (e.g., infrastructure change, migration change, system requirement change, data format change, etc.), the product/service/technology effected (e.g., hardware, software, middle-ware, application, etc.), the timing of the evolution (e.g., current, soon, concurrent with other risks, etc.) and the actual effect of the evolution (e.g., length of system down-time, decrease in system capacity, number of products/services/technologies effected, etc.). For example, a risk might be higher when it involves a data format change in the coming months that will cause a compatibility issue between a large number of essential products/services/technologies such that the subject enterprise architecture will suffer lengthy down-time if the risk is not addressed in advance. By contrast, a risk may be low where a single, non-essential product/service/technology will be comprised based on an evolution that is not scheduled to occur for several months or years.

The various risks identified by the risk identification module 208 are provided to IT providers either in list form or in a graphical representation. Each identified risk is associated with the corresponding evolution information and the products/services/technologies effected. For example, an IT provider may be provided with a list of each evolution that will effect a particular enterprise architecture that identifies the risk, the product/service/technology that is at risk, and the timing for each evolution. Similarly, an IT provider may be provided with a graphical representation of a particular enterprise architecture, such as the graphical representation generated with the virtualization software 214, that identifies at-risk products/services/technologies within the graphical representation via visual indicators (e.g., flashing, coloring red, highlighting, etc.). By clicking on or otherwise selecting a particular product/service/technology within that graphical representation, the IT provider will be provided with additional information, such as the risk, which evolutions are placing that product/service/technology at risk, and the timing of those evolutions. The IT provider may also be provided with a hybrid of those two media, wherein the IT provider can click on or otherwise select a particular evolution from a list and the products/services/technologies placed at risk by that evolution will be identified in the graphical representation. Accordingly, the risk identification module 208 not only identifies current and future risks to IT providers' enterprise architectures based on the evolution information provided by various vendors, it also presents those risks to the IT providers in a meaningful manner so that the IT providers can begin assessing those risks and planning projects to mitigate those risks.

The risk mitigation module 210 is configured to evaluate the risks identified by the risk identification module 208 and generate a mitigation schedule in which evolutions are placed in the order in which they should be addressed, according to both the risk associated with that evolution and the timing of that evolution. The risk mitigation module 210 also is configured to group related evolutions together so they can be addressed in a single, aggregated change. For example, the risk identification module 208 may identify two or more evolutions that are months apart but that effect the same product/service/technology. Accordingly, the risk mitigation module 210 will group those evolutions together so they may be addressed at the same time, and so the corresponding product/service/technology and/or the enterprise architecture only needs to be taken off line one time, rather than at a separate time for each evolution.

The risk identification module 208 also may identify a first evolution to a first product/service/technology that is scheduled to occur at a first time and a second evolution to a second product/service/technology that is scheduled to occur at a second time, wherein the first time is before the second time. If the second product/service/technology will be effected by the first evolution because the operation of the second product/service/technology is dependent in some way on the first product/service/technology, the risk mitigation module 210 may schedule both the first evolution and the second evolution to be addressed at the same time to ensure that the dependency relationship between the first product/service/technology and the second product/service/technology is not negatively effected by either evolution. Moreover, because the operation of the second product/service/technology is dependant in some way on the first product/service/technology, addressing both evolutions at the same time prevents an IT provider from having to take the second product/service/technology off line two separate times—once at the first time to address the first evolution and once at the second time to address the second evolution.

In addition, the risk mitigation module 210 may schedule an evolution to be addressed after the actual evolution occurs. For example, the risk mitigation module 210 may group several evolutions together based on their effect on one or more products/services/technologies or some other factor, wherein an earlier evolution has been identified as a low risk because it will not significantly compromise the enterprise architecture. The risk mitigation module 210 will assign a value, monetary or otherwise, to the loss of performance that will result from not addressing that earlier evolution as well as to the time that the product/service/technology and/or enterprise architecture will have to be off line to address that earlier evolution. By assigning such values to each of a plurality of evolutions, the risk mitigation module 210 may determine that the least amount of value is lost by addressing the earlier evolution with a later evolution, after the earlier evolution occurs but before the later evolution occurs, because the value of the loss of performance from not addressing the earlier evolution is less than the combined values of the time that the product/service/technology and/or enterprise architecture will have to be off line to address the earlier evolution and the later evolution at the same time (i.e., the value of the temporary loss of performance is less than the value saved by addressing the earlier evolution and the later evolution aggregately).

As the foregoing examples demonstrate, the risk mitigation module 210 is configured to evaluate different risks, group them according to different factors, and identify the optimal times and order in which the corresponding evolutions should be addressed. The optimal times and order correspond to the times and order in which the least amount of overall value will be lost in addressing those evolutions. The risk mitigation module 210 then uses that information to populate a mitigation schedule, which it provides to the IT providers. Such mitigation schedules provide IT providers with longer strategic management opportunities so they may defer, delay, and/or enhance changes to their customers' enterprise architectures in an aggregated and efficient manner. Thus, instead of taking an enterprise architecture off line to address evolutions after they occur, in a reactive manner, IT providers can address those evolutions well in advance, in a proactive manner. Moreover, instead of addressing each evolution individually as they occur, IT providers can address them aggregately based on such things as release dates, types of changes, types of applications, and interdependencies so as to minimize the value lost to the subject enterprise architecture. IT providers can thereby provider better services to their customers through preventative measures.

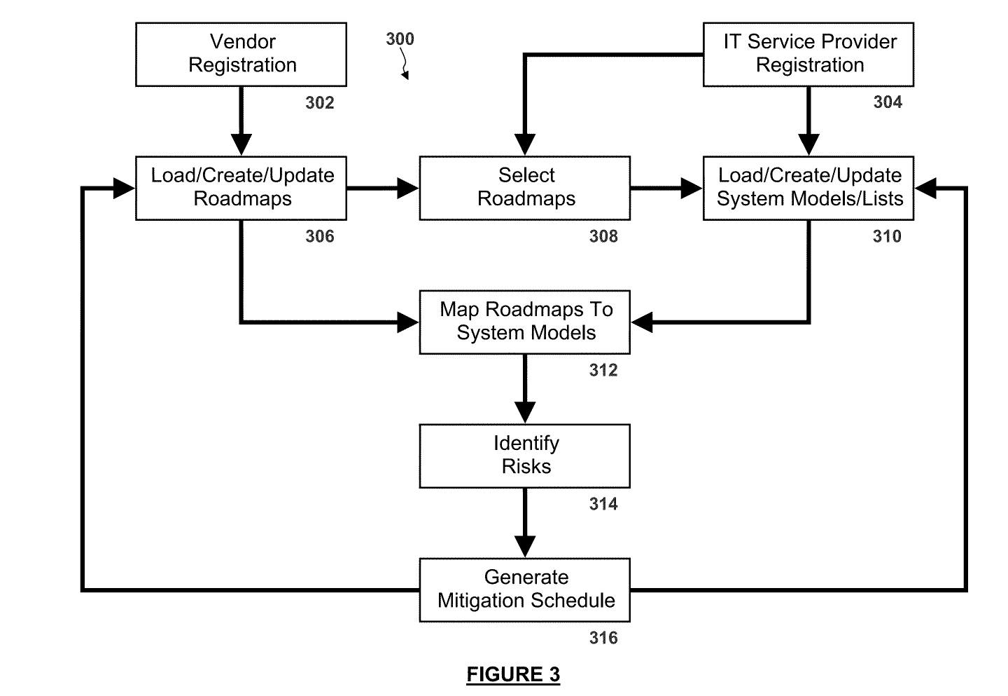

FIG. 3 illustrates a risk management process 300 that may be implemented by the risk management system 200 of FIG. 2, according to a non-limiting embodiment of the present disclosure. At step 302, vendors register with the data broker so that the products/services/technologies provided by those vendors can be verified by the broker. And at step 304, IT providers register with the data broker so that they may receive the IT providers services. Vendors and IT providers may register with the data broker by using their respective GUIs 108 and 112 to access the risk management system 200, such as via a web page.

After a vendor registers with the data broker at step 302, that vendor may utilize its PPM software 212 to load and/or modify the roadmaps for its various products/services/technologies on the roadmap construction module 202 at step 306. Also at step 306, the vendor may utilize PPM-type functionality provided by the roadmap construction module 202 to create and/or modify roadmaps for its various products/services/technologies. The roadmap construction module 202 utilizes that evolution information not only to support the various other functions of the risk management system 200, it also may publish that information to be shared among the registered vendors and IT providers, such as via a web page. Accordingly, the roadmap construction module 202 not only provides a mechanism for registered vendors to load, create, and modify roadmaps for their products/services/technologies, it also may serve as a web-based community where a large pool of evolution information for various vendors can be compiled, accessed, and shared among those vendors, as well as with IT providers. To maintain privacy, however, vendors may identify any products/services/technologies for which they do not want information to be shared, as well as the particular parties with whom they do not want it shared.

After an IT provider registers with the data broker at step 302, that IT provider utilizes the client watch list module 206 to select the specific products/services/technologies for which it would like to receive roadmaps at step 308. For example, the IT provider may select the specific products/services/technologies for which it would like to receive roadmaps from categorized lists of the products/services/technologies for which roadmaps have been loaded, created, and/or modified on the roadmap construction module 202. Or the IT provider may execute a search function across the database of the roadmap construction module 202 to identify and select those specific products/services/technologies. Based on those selections, the client watch list module 206 will filter all of the products/services/technologies in that database of the roadmap construction module 202 and provide the IT provider with a watch list of roadmaps for only those roadmaps that correspond to the selected products/services/technologies. Accordingly, the client watch list module 206 will notify the IT provider when a vendor updates or modifies a roadmap for one of those products/services/technologies of interest to that IT provider, rather than requiring that IT provider to seek out that information from vendors. It also prevents IT providers from only finding out about such updates or modifications after they have occurred, which is often too late.

Also after an IT provider registers with the data broker at step 302, that IT provider may utilize its virtualization software to load and/or modify the system models for its customers' enterprise architectures on the architecture modeling module 206 at step 310. The IT provider also may utilize virtualization functionality provided by the architecture modeling module 206 to create and/or modify system models or system lists for its customers' enterprise architectures at step 310. The architecture modeling module 206 may utilize those system models and system lists not only to support the various other functions of the risk management system 200, it also may publish that information to be shared among the registered vendors and IT providers, such as via a web page. Accordingly, the architecture modeling module 206 not only provides a mechanism for registered IT providers to load, create, and modify system models and system lists for their customers' enterprise architectures, it also may serve as a web-based community where a large pool of enterprise architecture information for various IT providers can be compiled, accessed, and shared among those IT providers, as well as with vendors. To maintain privacy, however, IT providers may identify any enterprise architectures for which they do not want information to be shared, as well as the particular parties with whom they do not want it shared.

If an IT provider creates a system model or system list using the virtualization functionality of the architecture modeling module 206 at step 310, that IT provider may create that system model or system list using the products/services/technologies selected at step 308. In that example, each product/service/technology selected for the system model already will be mapped to the corresponding roadmap. But if the IT provider loads a system model from its virtualization software 214 at step 310, the various products/services/technologies that make up the subject enterprise architecture may need to be mapped to the roadmaps for the corresponding products/services/technologies after the model is loaded to the architecture modeling module 206. That mapping is performed by the architecture modeling module 206 at step 312.

Step 308 may be skipped if an IT provider only wants to receive evolution information for the products/services/technologies that make up the enterprise architectures in the system models it has loaded on the risk management system 200 at step 310. Because the architecture modeling module automatically maps those products/services/technologies to the appropriate roadmaps at step 310, and because those system models will be used to identify risks at step 314, the IT provider will only be notified of updates or modifications to the roadmaps that correspond to the products/services/technologies represented in those system models. Accordingly, the IT provider may not need to narrow down the products/services/technologies of interest from all of those on the database of the roadmap construction module 202 at step 308. Instead, the products/services/technologies will be narrowed down automatically by the architecture modeling module 206 when it maps those products/services/technologies to the corresponding roadmaps.

As set forth above, there are two possible combinations of steps that can be followed between step 302 and step 314 of the risk management process 300 illustrated in FIG. 3. The first combination of steps (302→306→308→310, 304→308, and 304→310→312→314) may be followed if the IT provider creates a system model or system list with the visualization functionality of the architecture modeling module 206. The second combination of steps (302→306→312 and 304→310→312→314) may be followed if the IT provider loads a system model directly to the risk management system 200.

At step 314, the various risks associated with an IT provider's enterprise architectures are identified by the risk identification module 208 and provided to that IT provider in list form (e.g., in a system list) or in a graphical representation (e.g., in a system model). Each identified risk is associated with the corresponding evolution information that gave rise to that risk, as well as the particular products/services/technologies effected. Those risks are identified whenever the IT provider loads, creates, or modifies a system model, whenever an IT provider creates or modifies a system list, and whenever a vendor updates or modifies the roadmap for a product/service/technology that is utilized in an enterprise architecture represented in one of those system models or system lists. The IT provider can then obtain additional information on a particular product/service/technology that is identified as being at risk, as well as on the evolution(s) putting that particular product/service/technology at risk, by clicking on or otherwise selecting that particular product/service/technology from the list and/or graphical representation in which it is identified.

IT providers may be notified of such risks at step 314 via any suitable means (e.g., via e-mail, via automatic data push or pull, on a non-transitory storage medium, etc.) and in a data format that is most suitable for that vendor. For example, a file may be pushed to an IT provider's virtualization software 214 automatically whenever a vendor updates or modifies a roadmap in such a way that one or more of that IT provider's enterprise architectures is put at risk by the update or modification. That file may be provided in a format that can be seamlessly consumed by the IT provider's virtualization software 214 to provide a visualization of the subject risks via that IT provider's virtualization software 214. In the alternative, an IT provider may choose to receive an e-mail that includes a system list with the subject risks identified therein. As yet another alternative, the IT provider may be provided with a private account on the risk management system 200 through which that IT provider can access and view a list or graphical representation of the risks identified at step 314, such as via a web page.

After the various risks associated with an IT provider's enterprise architectures are identified by the risk identification module 208 at step 314, the risk mitigation module 210 generates a mitigation schedule at step 316. The risk mitigation module 210 evaluates different risks, groups them according to different factors, and identifies the optimal times and order in which the corresponding evolutions should be addressed. The optimal times and order correspond to the times and order in which the least amount of overall value will be lost in addressing those evolutions. The risk mitigation module 210 then uses that information to populate the mitigation schedule. Just as with the risk identifies, mitigation schedules may be provided to the IT providers via any suitable means and in a data format that is most suitable for that vendor. The IT provider then can properly evaluate the number of evolutions it needs to address so it can plan/instruct a project plan for implementing the required changes using “risk change bundling” (i.e., grouping changes to minimize the impact on the IT provider's customers' businesses by minimizing the down town required to make the required changes to those customers' enterprise architectures). That process may then be repeated any time a vendor updates or modifies a roadmap at step 306 and/or an IT provider updates or modifies a system model or system list at step 310.

Although the foregoing embodiments are described primarily in terms an iterative process in which data flows from one module to another before a mitigation schedule is provided to an IT provider by the risk mitigation module 210, IT providers may obtain data from the risk management module 200 at any point, depending on their particular needs. Accordingly, the risk management module 200 can be provided to IT providers as software as a service (SaaS) such that an IT provider can select which service it would like to receive, which may or may not include receiving a prediction schedule from the risk assessment module 210. For example, an IT provider may decide to perform its own, in-house risk assessment of its customers' enterprise architectures, in which case the IT provider may only want the roadmaps for the products/services/technologies that it uses or plans to use in its customers' enterprise architectures, which it can obtain from the client watch list module 204. Or an IT provider may decide that it does not need a prediction schedule, in which case the IT provider may only want risks to be identified by the risk identification module 208. Thus, the management module 200 can be configured to provide different IT providers with different levels of service according to those IT providers' different needs and desires, for which the data broker can charge different fees. Whatever level of service an IT provider chooses, the functionality of the risk management system 200 will provide that IT provider with the information necessary to create and associate risk mitigation plans and project planning actions.

By providing IT providers with such tools to plan ahead for future evolutions that may impact their customers' enterprise architectures, the disclosed embodiments allow those IT providers to mitigate risks that might otherwise compromise their customer's businesses, as well as the IT providers' relationships with their customers. For example, an IT provider can identify a group of upcoming evolutions that will effect the same set of products/services/technologies in a particular customer's enterprise with enough advance warning that all of those evolutions can be addressed ahead of time with a single, aggregate solution, rather than by several, disparate solutions, thereby reducing the total number and amount of times that the customer's business must be interrupted to address those evolutions. Moreover, such an aggregate solution can be implemented when it is convenient for the IT provider's customer (e.g., after business hours), rather than the customer's business being interrupted and/or compromised by an unexpected evolution when the enterprise architecture is most essential (e.g., during business hours).

The schematic and flow diagrams in FIGS. 1-3 illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. An apparatus for risk assessment for system architecture evolutions, the apparatus comprising:
a database comprising a plurality of roadmaps for a corresponding plurality of components that may be used to form an enterprise architecture, the roadmaps identifying the planned characteristics of the plurality of components,
a modeling module executed by a processor to identify the components that form the enterprise architecture, to identify the current characteristics of those components, and to map those components to the roadmaps for corresponding components among the plurality of components in the database; and
a risk identification module executed by the processor to identify which of the components that form the enterprise architecture have current characteristics that are different from the corresponding planned characteristics.

2. The apparatus of claim 1, further comprising a risk mitigation module executed by the processor to create a schedule for updating the components that form the enterprise architecture that have current characteristics that are different from the corresponding planned characteristics.

3. The apparatus of claim 2, wherein the risk mitigation module:
assigns a first value to a loss that will be experienced by the enterprise architecture if a first component of that enterprise architecture that has current characteristics that are different from the corresponding planned characteristics is updated at a particular time after the planned characteristic is implemented;
assigns a second value to a loss that will be experienced by the enterprise architecture if the first component is updated before the planned characteristic is implemented;
assigns a third value to a loss that will be experienced by the enterprise architecture if the first component is updated at the particular time after the planned characteristic is implemented, together with a second component of that enterprise architecture that has current characteristics that are different from the corresponding planned characteristics; and
schedules the first component and the second component to be updated together at the particular time after the planned characteristic when the first value and the second value yield a sum that is less than the third value.

4. The apparatus of claim 3, wherein the third value represents the loss that is attributable to the first component but not the second component.

5. The apparatus of claim 1, further comprising a roadmap construction module executed by the processor to receive input for defining the plurality of roadmaps that the database comprises.

6. The apparatus of claim 1, wherein the risk identification module identifies which of the components that form the enterprise architecture have current characteristics that are different from the corresponding planned characteristics by providing a visual indication in at least one of a list and a graphical representation displayed on a display.

7. The apparatus of claim 6, wherein:
the visual representation comprises the graphical representation; and
the graphical representation comprises abstractions that represent the components that form the enterprise architecture.

8. The apparatus of claim 7, wherein the modeling module is executed by the processor to:
receive a file that comprises abstractions that represent the components that form the enterprise architecture;
identify the components that form the enterprise architecture from data associated with the abstractions; and
map the components that form the enterprise architecture to the roadmaps for corresponding components among the plurality of components in the database using the data associated with the abstractions.

9. A method for assessing risks from system architecture evolutions comprising:
storing a plurality of roadmaps on a database, the plurality of roadmaps identifying planned characteristics of a plurality of components that may be used to form an enterprise architecture;
identifying the components that form the enterprise architecture and the current characteristics of those components;
mapping the identified components to the roadmaps for corresponding components among the plurality of components stored in the database; and
identifying which of the components that form the enterprise architecture comprise current characteristics that are different from the corresponding planned characteristics.

10. The method of claim 9, further comprising creating a schedule for updating the components that form the enterprise architecture that have current characteristics that are different from the corresponding planned characteristics.

11. The method of claim 10, wherein creating a schedule comprises:
assigning a first value to a loss that will be experienced by the enterprise architecture if a first component of that enterprise architecture that has current characteristics that are different from the corresponding planned characteristics is updated at a particular time after the planned characteristic is implemented;
assigning a second value to a loss that will be experienced by the enterprise architecture if the first component is updated before the planned characteristic is implemented;
assigning a third value to a loss that will be experienced by the enterprise architecture if the first component is updated at the particular time after the planned characteristic is implemented, together with a second component of that enterprise architecture that has current characteristics that are different from the corresponding planned characteristics; and
scheduling the first component and the second component to be updated together at the particular time after the planned characteristic when the first value and the second value yield a sum that is less than the third value.

12. The method of claim 11, wherein the third value represents the loss that is attributable to the first component but not the second component.

13. The method of claim 9, further comprising receiving input for defining the plurality of roadmaps stored in the database.

14. The method of claim 9, wherein identifying which of the components that form the enterprise architecture comprise current characteristics that are different from the corresponding planned characteristics comprises providing a visual indication in at least one of a list and a graphical representation displayed on a display.

15. The method of claim 14, wherein:
the visual representation comprises the graphical representation; and
the graphical representation comprises abstractions that represent the components that form the enterprise architecture.

16. The method of claim 15, wherein identifying the components that form the enterprise architecture and the current characteristics of those components comprises:
receiving a file that comprises abstractions that represent the components that form the enterprise architecture;
identifying the components that form the enterprise architecture from data associated with the abstractions; and
mapping the components that form the enterprise architecture to the roadmaps for corresponding components among the plurality of components in the database using the data associated with the abstractions.

17. A computer program product comprising a computer-readable storage medium having computer-readable program code embodied therewith, the computer-readable program code comprising:
computer-readable program code configured to store a plurality of roadmaps on a database, the plurality of roadmaps identifying planned characteristics of a plurality of components that may be used to form an enterprise architecture;
computer-readable program code configured to identify the components that form the enterprise architecture and the current characteristics of those components;
computer-readable program code configured to map the identified components to the roadmaps for corresponding components among the plurality of components stored in the database; and
computer-readable program code configured to identify which of the components that form the enterprise architecture comprise current characteristics that are different from the corresponding planned characteristics.

18. The computer program product of claim 17, further comprising computer-readable program code configured to create a schedule for updating the components that form the enterprise architecture that have current characteristics that are different from the corresponding planned characteristics.

19. The computer program product of claim 18, wherein computer-readable program code configured to create a schedule comprises:
computer-readable program code configured to assign a first value to a loss that will be experienced by the enterprise architecture if a first component of that enterprise architecture that has current characteristics that are different from the corresponding planned characteristics is updated at a particular time after the planned characteristic is implemented;
computer-readable program code configured to assign a second value to a loss that will be experienced by the enterprise architecture if the first component is updated before the planned characteristic is implemented;
computer-readable program code configured to assign a third value to a loss that will be experienced by the enterprise architecture if the first component is updated at the particular time after the planned characteristic is implemented, together with a second component of that enterprise architecture that has current characteristics that are different from the corresponding planned characteristics; and
computer-readable program code configured to schedule the first component and the second component to be updated together at the particular time after the planned characteristic when the first value and the second value yield a sum that is less than the third value.

20. The computer program product of claim 19, wherein the third value represents the loss that is attributable to the first component but not the second component.

21. The computer program product of claim 17, further comprising computer-readable program code configured to receive input for defining the plurality of roadmaps stored in the database.

22. The computer program product of claim 17, wherein computer-readable program code configured to identify which of the components that form the enterprise architecture comprise current characteristics that are different from the corresponding planned characteristics comprises computer-readable program code configured to provide a visual indication in at least one of a list and a graphical representation displayed on a display.

23. The computer program product of claim 22, wherein:
the visual representation comprises the graphical representation; and
the graphical representation comprises abstractions that represent the components that form the enterprise architecture.

24. The computer program product of claim 23, wherein computer-readable program code configured to identify the components that form the enterprise architecture and the current characteristics of those components comprises:
computer-readable program code configured to receive a file that comprises abstractions that represent the components that form the enterprise architecture;
computer-readable program code configured to identify the components that form the enterprise architecture from data associated with the abstractions; and
computer-readable program code configured to map the components that form the enterprise architecture to the roadmaps for corresponding components among the plurality of components in the database using the data associated with the abstractions.
